(19) United States
(12) Patent Application Publication
(10) Pub. No.: US 2005/0259576 A1
(43) Pub. Date: Nov. 24, 2005

(54) Information distributing system and information distributing method as well as information recording medium

(75) Inventor: Hiroshi Nakamura, Tokorozawa-shi (JP)

Correspondence Address: LADAS & PARRY, Suite #2100, 5670 Wilshire Boulevard, Los Angeles, CA, 90036-5679, US

(73) Assignee: PIONEER CORPORATION

(21) Appl. No.: 11/105,747

(22) Filed: Apr. 13, 2005

(30) Foreign Application Priority Data
Apr. 20, 2004 (JP) P2004-124572

(51) Int. Cl. H04L 12/26

(52) U.S. Cl. 370/229

(57) ABSTRACT

An information distributing system comprises a network, a server which outputs contents to be received in a terminal over a network, and a plurality of terminals each of which comprises a buffer for temporarily accumulating the contents distributed via the network and receives the contents. When the one terminal receives the contents, the accumulated contents are transmitted at a speed faster than a speed of outputting the contents from the server to the one terminal from the other terminal comprising the buffer where the contents are already accumulated.

### BACKGROUND OF THE INVENTION

1. Field of the Invention

The present invention relates to an information distributing system, an information distributing method as well as an information recording medium, and more particularly to an information distributing system including an output apparatus and a plurality of receivers which are interconnected via a network and an information distributing method performed in the information distributing system as well as an information recording medium storing the program for the information distributing processing therein.

2. Description of the Related Art

In recent years, distribution of moving picture information or the like using an asynchronous transmission network such as the Internet has been widely generalized.

Generally, a delay time in transmission is not constant in the asynchronous transmission network. Specifically, a difference (hereinafter, this difference is denoted as transmission time difference) occurs in an arrival time of information to a distribution destination due to a type of the information to be distributed and a change in congestion in the transmission network during distribution.

Thus, in order to absorb this transmission time difference, there has been employed a method for accumulating a certain amount of distributed information in a FIFO (First In First Out) buffer memory (hereinafter, simply denoted as buffer) at the distribution destination and then starting reproduction at the distribution destination.

More specifically, though so-called streaming broadcasting via the Internet (Internet TV broadcasting or Internet radio broadcasting) for personal computers is widely performed at present, a time of more than 10 seconds is spent for accumulating the information before reproduction, and a user who wants to receive the distribution during the time has to wait for the reproduction start of the distributed information.

Further, since this waiting operation occurs each time reception of the streaming broadcasting is started, if the user selects several broadcasting stations similarly to the station selecting operation in the broadcasting, the waiting time occurs in each time.

Here, the above problems will be described more specifically using FIG. 1.

Now, in FIG. 1, the broken line indicates a reception rate in a receiver after passing through the asynchronous transmission network and the solid line indicates a transmission rate (assumed to be constant) at an information sending side. The reception rate varies according to a time in the asynchronous transmission network as shown in FIG. 1. In order to accurately process information in the receiver where the reception rate varies in this manner, a processing has to be started after accumulating at least information for an area of “B” shown in FIG. 1 in the buffer. Further, the buffer in the receiver must have a margin for an area of “A” shown in FIG. 1 at the time of the processing start. Since the areas of “A” and “B” vary according to the performance of the asynchronous communication network or the information distributed at the same time, the buffer having a large remaining capacity is generally provided inside the receiver-so that a large amount of information is accumulated and then an information processing such as image outputting is started.

In this case, since the information processing is not started until the accumulation of necessary information in the buffer is terminated, the user is forced to have an unnecessary waiting time.

### SUMMARY OF THE INVENTION

The present invention has been made in terms of the above problems, and it is an object thereof to provide an information distributing system capable of rapidly starting a necessary information processing in a receiver which receives streaming broadcasting and an information distributing method performed in the information distributing system as well as an information recording medium storing the program for the information distributing processing therein.

The invention according to claim 1 relates to an information distributing system comprising a network, an output device which outputs distributed information to be received in the receiver over the network, and a plurality of the receivers each of which comprises an accumulating device for temporarily accumulating the distributed information distributed via the network and receives the distributed information, the system comprising:
a transmitting device which, when the one receiver receives the distributed information, can transmit the accumulated distributed information at a speed faster than a speed of outputting the distributed information from the output device to the one receiver from the other receiver comprising the accumulating device where the distributed information is already accumulated; and
a transmission control device which controls transmission of the distributed information from the other receiver using the transmitting device to the one receiver.

The invention according to claim 8 relates to an information distributing method performed in an information distributing system comprising a network, an output device which outputs distributed information to be received in a receiver over the network, and a plurality of the receivers each of which comprises an accumulating device for temporarily accumulating the distributed information distributed via the network and receives the distributed information, the method comprising:
a process which, when the one receiver receives the distributed information, transmits the accumulated distributed information at a speed faster than a speed of outputting the distributed information from the output device to the one receiver from the other receiver comprising the accumulating device where the distributed information is already accumulated.

The invention according to claim 9 relates to an information recording medium, in which an information distributing program is computer-readably recorded, the information distributing program causing a computer to function as a transmission control device which controls transmission of the distributed information from other receiver using a transmitting device to one receiver,
said computer being included in an information distributing system comprising a network, an output device which outputs distributed information to be received in a receiver over the network, a plurality of the receivers each of which comprises an accumulating device for temporarily accumulating the distributed information distributed via the network and receives the distributed information, and a transmitting device which can transmit the accumulated distributed information at a speed faster than a speed of outputting the distributed information from the output device to the one receiver from the other receiver comprising the accumulating device where the distributed information is already accumulated.

### BRIEF DESCRIPTION OF THE DRAWINGS

FIG. 1 is a timing chart for explaining the problems of the prior art;

FIG. 2A and FIG. 2B are principle explanatory diagrams of the present invention, where FIG. 2A is the principle explanatory diagram (I) and FIG. 2B is the principle explanatory diagram (II);

FIG. 3 is a timing chart for explaining the principle of the present invention;

FIG. 4 is a block diagram showing the inner structure of a server according to embodiments;

FIG. 5 is a block diagram showing the inner structure of a terminal according to the embodiments;

FIG. 6 is a flowchart showing an information distributing processing according to a first embodiment; and

FIG. 7 is a flowchart showing an information distributing processing according to a second embodiment.

### DETAILED DESCRIPTION OF THE PREFERRED EMBODIMENTS

Embodiments according to the present invention will be described using the drawings. Each embodiment described below is one where the present invention is applied to an information distributing system including a server as an output apparatus and terminals as a plurality of receivers which are interconnected via a network such as the Internet.

(I) Principle of the Present Invention

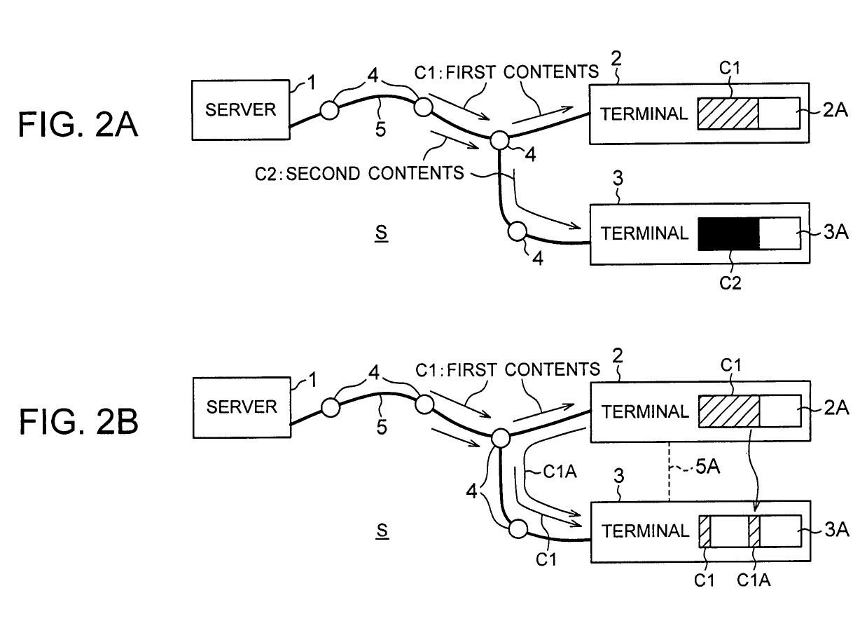

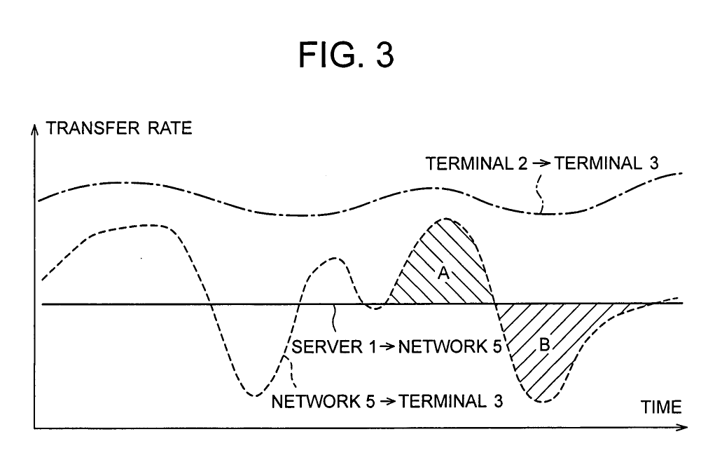

The principle of the present invention will be initially described using FIGS. 2 and 3 before explaining the embodiments according to the present invention. FIG. 2 is a block diagram showing a schematic structure of the information distributing system according to the present invention, and FIG. 3 is a diagram showing a relationship between a transfer rate and a time when the present invention is applied.

According to the present invention, when one terminal receives necessary information from the server, the terminal receives the information to be received also from another terminal which has already received the information when the reception is started, and accumulation of the information in a buffer in the one terminal is made faster, thereby accelerating a start of the processing of the received information in the one terminal.

Specifically, as shown in FIG. 2, an information distributing system S according to the present invention comprises a server 1 which outputs information to be distributed (hereinafter, a clump of information to be distributed is denoted as contents), terminals 2 and 3 which receive necessary contents, and a network 5 which includes a plurality of routers 4 on the path thereof and connects the server 1 and the respective terminals 2 and 3.

Before the information transmitting processing according to the present invention is started, the terminal 2 has received first contents C1 via the network 5 and the first contents C1 have been in order of reception accumulated in a buffer 2A in the terminal 2 as shown in FIG. 2A. Concurrently with the above, the terminal 3 has received second contents C2 via the network 5 and the second contents C2 have been in order of reception accumulated in a buffer 3A in the terminal 3.

Next, it is assumed that the contents to be received in the terminal 3 are changed from the past second contents C2 to the first contents C1 in the state shown in FIG. 2A. In this case, all the first contents C1 accumulated so far are deleted and reception of the second contents C2 from the server land accumulation of the received second contents C2 are newly started in the buffer 3A in the terminal 3. In the present invention, the accumulated contents (that is, the first contents C1) in the buffer 2A in the terminal 2 are transmitted from the terminal 2 to the terminal 3 at the same time with the above. At this time, the transmission of the first contents C1 is performed at a transmission rate faster than a normal transmission rate via the network 5 from the oldest information among the information accumulated in the buffer 2A.

As a result, in the terminal 3, first contents C1A to be received from the terminal 2 and accumulated in the buffer 3A can be used to start the information processing for the first contents C1 to be originally received from the server 1 before a certain amount of information is accumulated in the buffer 3A, unlike conventional manner.

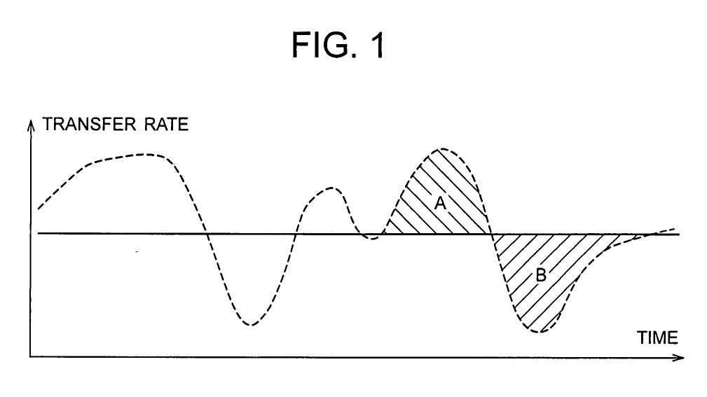

Furthermore, the information transmission from the terminal 2 to the terminal 3 is performed more rapidly than the original transmission rate via the network 5 from the server 1 so that the terminal 3 can immediately start the information processing without performing buffering of the first contents C1 when the first contents C1 have arrived from the terminal 2. This is because when the information is transmitted from the terminal 2 at the transmission rate (shown in a chain line in FIG. 3) at which the portion of “B” in FIG. 1 does not occur, the buffering is not required in the terminal 3. When the first contents C1 are transmitted from the terminal 2 to the terminal 3 at such fast transmission rate, even if the transmission time difference is present in case where the terminal 3 receives the necessary first contents C1 from the server 1, the reception rate for the entire first contents C1 in the terminal 3 is rarely slower than the sending rate of the first contents C1 from the server 1. Thus, the buffering is not required, thereby accelerating the start of the information processing for the first contents C1 in the terminal 3.

A path of the information transmission from the terminal 2 to the terminal 3 may use the network 5 as it is. But when a network 5A such as private line which directly connects the terminal 2 and the terminal 3 is used separately from the network 5, it is not easily influenced by congestion in the network 5, the first contents C1 can be rapidly transmitted from the terminal 2 to the terminal 3.

### (II) First Embodiment

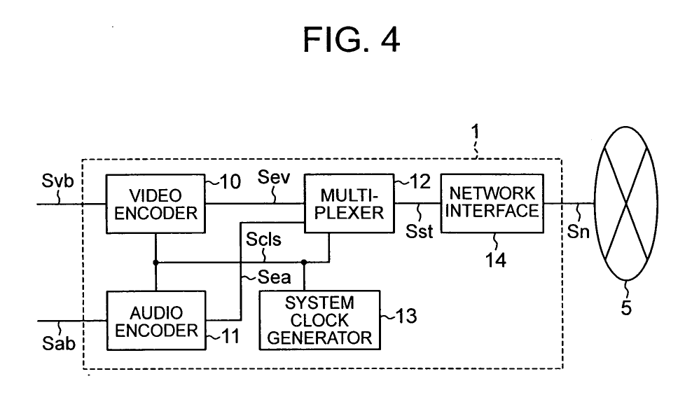

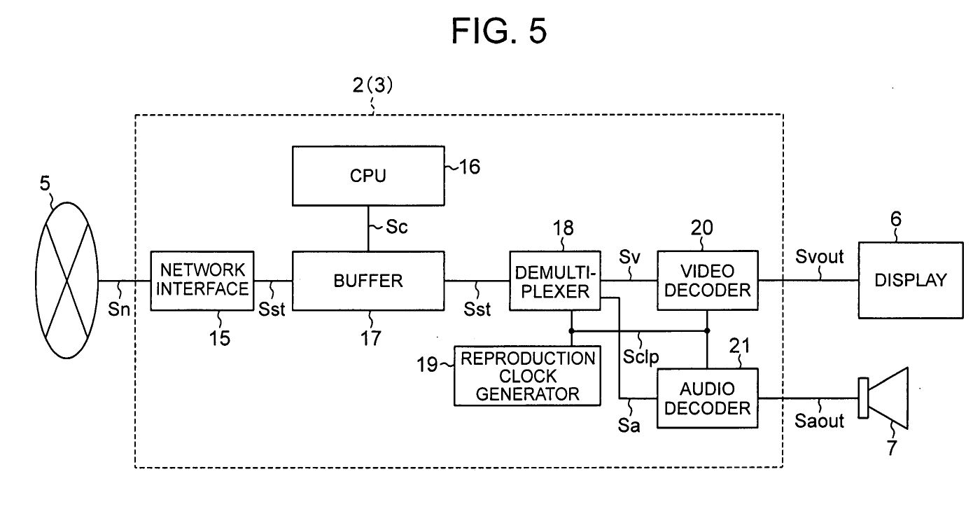

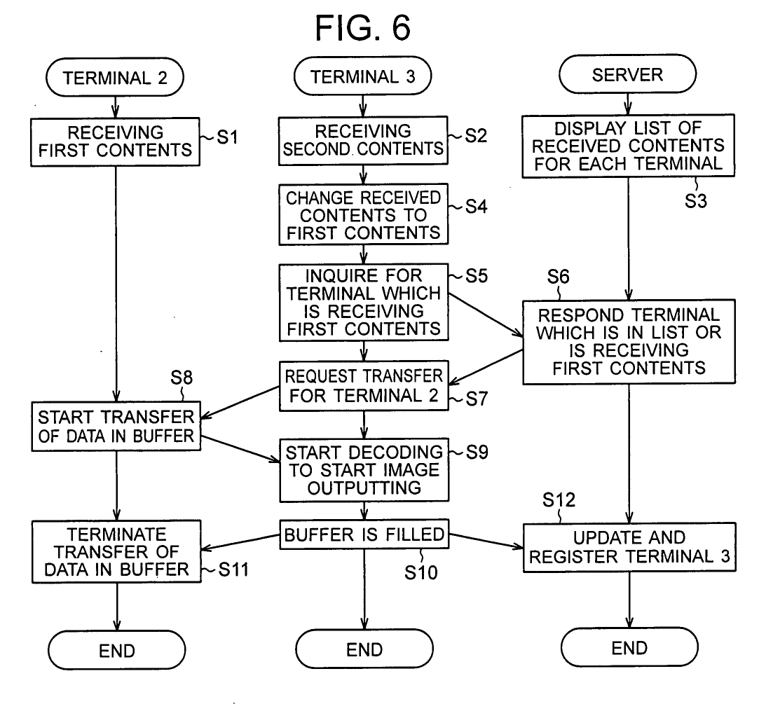

Next, a first embodiment according to the present invention based on the above principle will be specifically described using FIGS. 4 to 6. FIG. 4 is a block diagram showing a schematic structure of a server according to the first embodiment, FIG. 5 is a block diagram commonly showing a schematic structure of each terminal according to the first embodiment, and FIG. 6 is a flowchart showing an information distributing processing according to the first embodiment.

The entire structure of an information distributing system S according to the first embodiment is similar to the information distributing system S described above using FIG. 2, and comprises the server 1 which is one example of an output apparatus for outputting contents, the terminals 2 and 3 which are one example of the receiver for receiving necessary contents, and the network 5 which includes a plurality of routers 4 on the path thereof and is one example of a transmitting device for connecting the server 1 and the respective terminals 2 and 3.

As a specific example of the terminals 2 and 3, terminal 2 may be one centralized terminal provided in an apartment and a terminal 3 may be a personal computer provided at one home thereof. Further, the terminal 2 may be a server in an in-house local network and the terminal 3 may be a personal computer used by each member in the company. In this manner, the relationship between the terminal 2 and the terminal 3 which can transmit contents at a speed faster than a speed for distributing contents from the server 1 according to the first embodiment to the terminal 3 corresponds to the first embodiment.

In addition to the above example, both the terminals 2 and 3 may be dedicated terminals such as STB (Set Top Box) for receiving streaming broadcasting.

Next, the server 1 comprises a video encoder 10, an audio encoder 11, a multiplexer 12, a system clock generator 13, and a network interface 14 as shown in FIG. 4.

On the other hand, the terminals 2 and 3 have the structures similar to each other, and specifically each thereof comprise a network interface 15, a CPU 16 as one example of a transmission control device, a buffer 17 as one example of an accumulating device, a demultiplexer 18, a reproduction clock generator 19, a video decoder 20, and an audio decoder 21 as shown in FIG. 5.

Next, the respective operations will be described.

As shown in FIG. 4, when a content distribution request is issued from either terminal 2 or 3 and original image information Svb to be distributed as the contents (including at least one of moving picture information and still image information) is supplied from the outside, the video encoder 10 in the server 1 encodes the original image information Svb with a system clock signal Scls from the system clock generator 13 as a reference, and generates encoded image information Sev and outputs the same to one input terminal of the multiplexer 12.

On the other hand, concurrently with the above, when original audio information Sab to be distributed as contents is supplied from the outside, the audio encoder 11 encodes the original audio information Sab with the system clock signal Scls as a reference, and generates encoded audio information Sea and outputs the same to the other input terminal of the multiplexer 12.

Then, the multiplexer 12 superimposes the encoded image information Sev and the encoded audio information Sea with the system clock signal Scls as a reference and adds necessary control information such as clock reference information, and generates superimposed information Sst for the stream broadcasting and outputs the same to the network interface 14.

Thus, the network interface 14 performs a preset output interface processing for the superimposed information Sst, and transmits the same as contents Sn via the network 5 to the terminal 2 or 3 which has issued the distribution request.

When the terminal 2 or 3 which has issued the distribution request receives the contents Sn via the network 5, the network interface 15 in the terminal 2 or 3 performs a preset input interface processing for the contents Sn, and recovers the original-superimposed information Sst and outputs the same to the buffer 17.

Thus, the FIFO buffer 17 accumulates the superimposed information Sst in the FIFO form in inputting order. At this time, the accumulation of the superimposed information Sst in the buffer 17 is controlled based on a control signal Sc from the CPU 16.

Next, the superimposed information Sst output from the buffer 17 is separated into image information and audio information by the demultiplexer 18 with a reproduction clock signal Sclp generated in the reproduction clock generator 19 based on the clock reference information contained in the superimposed information Sst as a reference, and they are output as image information Sv and audio information Sa to the video decoder 20 and the audio decoder 21, respectively.

The video decoder 20 decodes the image information Sv with the reproduction clock signal Sclp as a reference, and generates decoded image information Svout and outputs the same to an external display 6, and displays an image corresponding to the decoded image information Svout.

On the other hand, concurrently with the above, the audio decoder 21 decodes the audio information Sa with the reproduction clock signal Sclp as a reference, and generates decoded audio information Saout and outputs the same to an external speaker 7, and broadcasts an audio corresponding to the decoded audio information Saout.

In addition to the respective operations described above, the CPU 16 generates the control signal Sc in order to control the accumulation state in the buffer 17 and outputs the same to the buffer 17, and controls each constituent constituting the terminal 2 or 3 such that the information distributing processing according to the first embodiment described later is performed.

Next, the entire information distributing processing according to the first embodiment, which is performed in the information distributing system S for realizing the above structure and operations, will be described using FIG. 6.

In the information distributing system S according to the first embodiment, in addition to the structures of the server 1 and the terminals 2 and 3, the server 1 has a function of generating and recording a list of received contents which indicates which of the terminals 2 and 3 has received distribution of which type of contents, and the type of the contents which have been actually distributed is acquired for each terminal 2 or 3 and is displayed in the network 5 in a viewable manner from each terminal 2 or 3.

In this state, in the information distributing processing according to the first embodiment, as shown in FIG. 6, the terminal 2 is initially receiving the first contents C1 and is accumulating the same in the buffer 2A (step S1), the terminal 3 is receiving the second contents C2 and is accumulating the same in-the buffer 3A (step S2), and further the server 1 is displaying the list of received contents in the network 5 (step S3).

When a processing of changing contents to be received in the terminal 3 from the second contents C2 to the first contents C1 is performed in the terminal 3 through the operation by an operating portion (not shown) in the terminal 3 (step S4), the CPU 16 of the terminal 3 inquires of the server 1 about other terminal which is currently receiving the first contents C1 (step S5).

Thus, when the server 1 responds that the terminal which is receiving the first contents C1 is the terminal 2 (step S6), the CPU 16 which has received the response transmits to the terminal 2 a request of transmitting the first contents C1 accumulated in the terminal 2 to the terminal 3 (step S7), and the CPU 16 in the terminal 2 which has received the request transmits the first contents C1 accumulated in the buffer 2A in response to the request from the header information (for example, I (Intra-coded) picture positioned at the head of GOP (Group of Picture) in the MPEG standard when the first contents C1 conform to MPEG (Moving Picture Expert Group)standard) to the terminal 3 (step S8).

At this time, in the terminal 3, the reception of the first contents C1 from the server 1 and the reception of the first contents C1 from the terminal 2 are concurrently performed. Further, the CPU 16 in the terminal 3 controls the buffer 17, for example, while referring to address information or the like in the first contents C1 in the respective parts such that a part of the first contents C1 received from the server 1 and a part of the first contents C1 received from the terminal 2 are different from each other.

The terminal 3 which has received the transmission performs a reproducing processing such as reproducing the first contents C1 received from the terminal 2 from the header thereof and outputting the same as an image to the display 6 (step S9), and when the buffer 2A is filled (step S10), transmits the fact to the terminal 2 and stops the transmission of the first contents C1 from the terminal 2 (step S11). Concurrently with the above, the CPU 16 of the terminal 3 notifies to the server 1 the fact that the buffer 2A is filled and the terminal 3 is receiving the first contents C1, and updates the list of received contents (step S12).

As described above, according to the information distributing processing in the information distributing system S according to the first embodiment, when the first contents C1 are received in the terminal 3, the accumulated first contents C1 are distributed from other terminal 2 to the terminal 3 at a speed faster than a speed of outputting the first contents C1 from the server 1. Thus, the necessary first contents C1 can be rapidly received and accumulated in the terminal 3, and the first contents C1 can be rapidly reproduced and output in the terminal 3.

Since the first contents C1 are transmitted from an image positioned at the header of the first contents C1 to be received in the terminal 3, the first contents C1 can be rapidly reproduced and output in the terminal 3.

Further, since the terminal 2 to which the first contents C1 can be transmitted is previously searched and registered, when the distribution of the first contents C1 from the server 1 is started, the terminal 2 to which the first contents C1 can be transmitted can be immediately found and can receive the transmission.

Furthermore, control is made such that the part of the first contents C1 to be transmitted from the server 1 to the terminal 3 and the part of the first contents C1 to be transmitted from the terminal 2 to the terminal 3 are different from each other. Thus, the overlapped first contents C1 are not accumulated in the buffer 3A, thereby distributing the first contents C1 more efficiently while saving use of the recording area in the buffer 3A.

### (III) Second Embodiment

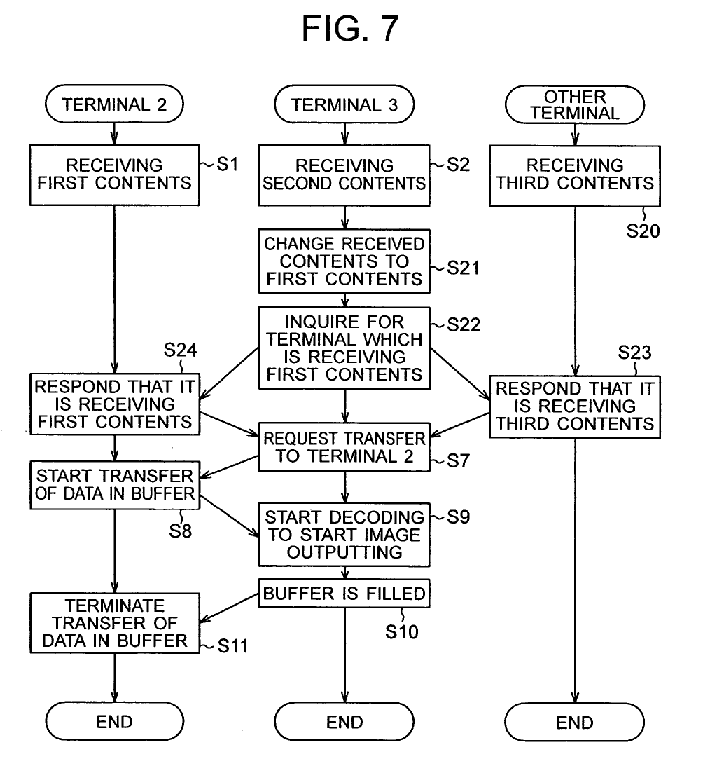

Next, a second embodiment according to the present invention will be described using FIG. 7.

FIG. 7 is a flowchart showing an information distributing processing according to the second embodiment. The structure of an information distributing system according to the second embodiment described later is basically similar to the information distributing system S according to the first embodiment, but a third terminal is included in the information distributing system in addition thereto. The information distributing processing according to the second embodiment will be described using reference numerals identical to those in the first embodiment in case of need. Further, in the flowchart shown in FIG. 9, similar processings as in the flowchart shown in FIG. 8 are denoted with similar step numerals added and detailed description thereof will be omitted.

There has been described the structure where the server 1 manages the list of received contents and each terminal 2 or 3 refers to the same in case of need in the first embodiment, but the information distributing processing according to the present invention will be performed instead of using the server 1 in the second embodiment described later.

Specifically, in the information distributing processing according to the second embodiment, the terminal 2 is initially receiving the first contents C1 and is accumulating the same in the buffer 2A (step Si), the terminal 3 is receiving the second contents C2 and is accumulating the same in the buffer 3A (step S2), and other terminal which is the third terminal is receiving third contents and is accumulating the same in a buffer thereof (step S20).

When a processing of changing contents to be received in the terminal 3 from the second contents C2 to the first contents C1 is performed in the terminal 3 through the operation by the operating portion (not shown) in the terminal 3 (step S21), the CPU 16 of the terminal 3 inquires of all other terminals in the same network 5 whether the first contents C1 are being received (step S22).

Thus, since the terminal 2 responds that it is receiving the first contents C1 (step S24) while other terminal responds that it is receiving the third contents (step S23), the CPU 16 of the terminal 3 transmits to the terminal 2 a request of transmitting the first contents C1 accumulated in the terminal 2, which has responded that it is receiving the first contents C1, to the terminal 3 (step S7), and then the processings in steps 8 to 11 in the information reproducing processing according to the first embodiment are performed.

Specifically, the terminal 3 performs the reproducing processing such as reproducing the first contents C1 received from the terminal 2 from the head thereof and outputting the same as image to the display 6 (step S9), and when the buffer 2A is filled (step S10), transmits the fact to the terminal 2 and stops the transmission of the first contents C1 from the terminal 2 (step S11).

As described above, the same effects as in the information distributing processing according to the first embodiment can be also obtained through the information distributing processing in the information distributing system according to the second embodiment.

Each program corresponding to the flowchart in FIG. 6 or 7 is recorded in an information recording medium such as flexible disk or HD or is recorded after the program is acquired via the network such as the Internet and then is read out by a general-purpose microcomputer to be realized, so that the microcomputer can function as the CPU 16 of each terminal according to the embodiments.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2004-124572 filed on Apr. 20, 2004 including the specification, claims, drawings and abstract is incorporated herein by reference in its entirety.

1. An information distributing system comprising a network, an output device which outputs distributed information to be received in the receiver over the network, and a plurality of the receivers each of which comprises an accumulating device for temporarily accumulating the distributed information distributed via the network and receives the distributed information, the system comprising:
a transmitting device which, when the one receiver receives the distributed information, can transmit the accumulated distributed information at a speed faster than a speed of outputting the distributed information from the output device to the one receiver from the other receiver comprising the accumulating device where the distributed information is already accumulated; and
a transmission control device which controls transmission of the distributed information from the other receiver using the transmitting device to the one receiver.

2. An information distributing system according to claim 1, wherein the transmission control device controls such that the distributed information is transmitted from the other receiver to the one receiver from header information positioned at the head of the distributed information to be received in the one receiver.

3. An information distributing system according to claim 1, wherein the transmission control device further comprises a searching device which previously searches for the other receiver capable of transmitting the distributed information from among the plurality of receivers.

4. An information distributing system according to claim 1, wherein the transmission control device controls transmission of the distributed information from the output device to the one receiver and transmission of the distributed information from the other receiver to the one receiver such that a part of the distributed information to be transmitted from the output device to the one receiver and a part of the distributed information to be transmitted from the other receiver to the one receiver are different from each other.

5. An information distributing system according to claim 1, wherein the other receiver comprises:
the accumulating device; and
the transmission control device.

6. An information distributing system according to claim 1, wherein the one receiver comprises:
the accumulating device; and
the transmission control device.

7. An information distributing system according to claim 1, wherein the output device comprises the transmission control device.

8. An information distributing method performed in an information distributing system comprising a network, an output device which outputs distributed information to be received in a receiver over the network, and a plurality of the receivers each of which comprises an accumulating device for temporarily accumulating the distributed information distributed via the network and receives the distributed information, the method comprising:
a process which, when the one receiver receives the distributed information, transmits the accumulated distributed information at a speed faster than a speed of outputting the distributed information from the output device to the one receiver from the other receiver comprising the accumulating device where the distributed information is already accumulated.

9. An information recording medium, in which an information distributing program is computer-readably recorded, the information distributing program causing a computer to function as a transmission control device which controls transmission of the distributed information from other receiver using a transmitting device to one receiver,
said computer being included in an information distributing system comprising a network, an output device which outputs distributed information to be received in a receiver over the network, a plurality of the receivers each of which comprises an accumulating device for temporarily accumulating the distributed information distributed via the network and receives the distributed information, and a transmitting device which can transmit the accumulated distributed information at a speed faster than a speed of outputting the distributed information from the output device to the one receiver from the other receiver comprising the accumulating device where the distributed information is already accumulated.
